(19) United States
(12) Patent Application Publication
(10) Pub. No.: US 2024/0287307 A1
(43) Pub. Date: Aug. 29, 2024

(54) FUNCTIONALIZED CORE-SHELL POLYSILSESQUIOXANE PARTICLES

(71) Applicants: Dow Global Technologies LLC, Midland, MI (US); Dow Silicones Corporation, Midland, MI (US)

(72) Inventors: Zachary S. Kean, Bay City, MI (US); Steven Swier, Midland, MI (US); Daniel G. Abebe, Lake Jackson, TX (US); Sydonie D. Schimler, Midland, MI (US)

(21) Appl. No.: 18/561,135

(22) PCT Filed: Jul. 13, 2022
(86) PCT No.: PCT/US2022/036891

§ 371 Date: Nov. 15, 2023

Related U.S. Application Data
(60) Provisional application No. 63/241,128, filed on Sep. 7, 2021.

(51) Int. Cl. C08L 83/04; C08J 3/12

(52) U.S. Cl. CPC C08L 83/04; C08J 3/126; C08J 2383/04; C08J 2483/06; C08L 2207/53

(57) ABSTRACT

A composition includes a core-shell polyorganosiloxane particle having an average particle size in a range of 50-150 nanometers, the core-shell polyorganosiloxane particle comprising: (a) a core with a core polyorganosilsesquioxane; and (b) a shell coating the core comprises a shell polyorganosiloxane that is a functionalized polyorganosiloxane different from the core poly-organosilsesquioxane; where the shell is greater than zero and less than 20 weight-percent of the core-shell polysiloxane particle weight and less than 25 percent of the particle diameter.

### FIELD OF THE INVENTION

The present invention relates to core-shell particles having a polysilsesquioxane-based core and a functionalized polyorganosiloxane shell, aqueous dispersions of such particles and methods for making such particles.

### INTRODUCTION

Polyorganosiloxane particles are useful in many different compositional applications to impart hardness, toughness, water resistance properties to compositions and/or even high voltage break down resistance properties. Polyorganosiloxane particles can provide superior high temperature resistance, weathering stability (UV, temperature, and water), dielectric strength and hydrophobicity as compared to particles based on organic building blocks.

It is desirable to develop a polyorganosiloxane particle that has versatility so it can be used in multiple applications and environments. The chemical character of polyorganosiloxane particles effects how well the polyorganosiloxane particles can be dispersed into a particular medium and can also affect whether or not the particle can participate in chemical reactions. Therefore, it is desirable to be able to control the chemical character of the polyorganosiloxane particles to make them compatible with a particular environment, chemically reactive in a desirable way, or both. However, preparing particles out of different polyorganosiloxane materials can get expensive and even wasteful considering the polyorganosiloxane component interior to the particles has little to no effect on how well the particle disperses or chemically reacts after it is made. Therefore, it is desirable to identify how to prepare polyorganosiloxane particles where the surface can be modified chemically but the core can be a relatively inexpensive inert polyorganosiloxane.

The particle size of the polyorganosiloxane particles can also be important. For instance, wire and cable applications benefit from high voltage breakdown properties and it has been calculated that particle additives in the size range of 50-100 nanometers (nm) act as optimum electron traps when dispersed in low density polyethylene matrices. That can be a challenging particle size range in which to controllably prepare particles, let alone one where you can modify the surface chemical properties.

Yet more desirable is a polyorganosiloxane particle that can be prepared in an aqueous environment. Syntheses in organic solvents undesirably result in organic solvent that is typically only used as a synthesis medium and needs to be removed prior to use, particularly in an aqueous composition. Particles delivered in an aqueous medium can be easily delivered into other water-based emulsions or dispersions to provide the above mentioned benefits to, for example, organic matrices. This will contribute to trends in environmentally friendly delivery of products in applications like protective coatings, encapsulants, composites and adhesives.

It would advance the art to provide a polyorganosiloxane particle that has an average particle size in a range of 50 to 150 nanometers (nm), preferably 80 to 150 nm, more preferably 80 to 100 nm, that has a surface chemistry that can be modified apart from the core composition and that can be prepared in an aqueous environment.

### BRIEF SUMMARY OF THE INVENTION

The present invention provides a solution to the problem of providing a polyorganosiloxane particle that has an average particle size in a range of 50 to 150 nanometers (nm), 80 to 150 nm, even 80 to 100 nm, that has a surface chemistry that can be modified apart from the core composition and that can be prepared in an aqueous environment.

The invention is a result of discovering that it is possible to prepare polyorganosiloxane particles with average particle sizes in a range of 50 to 150 nm, 80 to 150 nm, 80 to 100 nm, and even 50 to 100 nm in an aqueous environment as core-shell particles with a silsesquioxane-based core and a polyorganosiloxane shell. The core can be a relatively inexpensive alkyl-modified silsesquioxane such as methyl-silsesquioxane. The shell can be a versatile polyorganosiloxane that can comprise functional groups to render the polyorganosiloxane particle chemically reactive, can have compatiblizing moieties to render the polyorganosiloxane particle compatible with a particularly desirable composition, or both. The shell can be 20 weight-percent (wt %) or less of the particle weight. Expressed in another way, the shell can be 25 percent (%) or less, 20% or less, even 15% or less, or 10% or less of the particle diameter. As a result, the expensive versatile polyorganosiloxane that dictates the particle's chemical character can be a very minor component yet control the chemical character of the resulting particle without wasting cost and versatile polyorganosiloxane as core material to a particle.

Even more surprising is that the particles of the present invention can be made using an anionic surfactant without the presence of cationic surfactants or even nonionic surfactants, resulting in particles that can have residual anionic surfactant. This is surprising in view of prior art suggesting particle size control in this range is accomplished with a “Size Controlled Emulsion Polymerization Method” that requires a combination of cationic and nonionic surfactant (see, for example, Arkhireeva et al, Journal of Non-Crystalline Solids 351 (2005) 1688-1695).

In a first aspect, the present invention is a composition comprising a core-shell polyorganosiloxane particle having an average particle size in a range of 50-150 nanometers, the core-shell polyorganosiloxane particle comprising: (a) a core comprising a core polyorganosilsesquioxane; and (b) a shell coating the core comprises a shell polyorganosiloxane that is a functionalized polyorganosiloxane different from the core polyorganosilsesquioxane; where the shell is greater than zero and less than 20 weight-percent of the core-shell polysiloxane particle weight and less than 25 percent of the particle diameter.

In a second aspect, the present invention is a method for preparing the composition of the first aspect, the method comprising performing the following steps sequentially: (a) feeding a core alkyltrialkoxy silane into an aqueous solution of base and anionic surfactant at a temperature of 30 degrees Celsius or higher while stirring in order to polymerize the core alkyltrialkoxy silane into polyorganosilsesquioxane core particles dispersed in the aqueous solution; and then (b) feeding a first polymerizable shell silane that is different from the core alkyltrialkoxy silane into the aqueous solution containing dispersed polyorganosilsesquioxane core particles at a temperature of 30 degrees Celsius or higher while stirring to polymerize the first polymerizable shell silane around the core particles to form a dispersion of core-shell polyorganosiloxane particles.

The composition of the present invention is useful for providing functionalized and/or compatibilized polysiloxane particles suitable for any of a number of applications such as textile applications to, for example, render textiles water resistant; for inclusion in polyethylene matrices for wire and cable applications to enhance voltage breakdown; as additives in paint formulations to improves hardness, toughness, water/stain resistance and block resistance; and as additives in elastomeric roof coatings where they may promote water swell resistance.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; EN refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

“Alkyl” refers to a hydrocarbon radical derivable from an alkane by removal of a hydrogen atom. An alkyl can be linear or branched.

“Core-Shell” structure refers to a particle structure where there are definite compositional domains with one domain (the “core”) central to the particle and another domain (the “shell”) on the surface, preferably surrounding, the core. The core-shell structure can have a single core with multiple “shells” coating it, which means there are more than one distinct domain around the core domain. Core-shell structure for particles can be confirmed by transmission electron micrography (TEM) and/or X-ray photoelectron spectroscopy (XPS) as described herein, below.

“Dispersion” refers to a mixture of materials comprising particles of one material that are dispersed in a continuous phase of another material.

“Functionalized” means having more than 10 mole-percent (mol %), preferably 20 mol % or more, more preferably 25 mol % or more, even more preferably 30 mol % or more functional groups bound thereto with mol % relative to silicon atoms.

“Functional group” refers to a moiety of a molecule that provides the molecule with chemical properties other than that of a hydrocarbon. Preferably, functional groups provide a molecule with chemical reactivity through the functional group. Examples of functional groups include alkenyl groups, alkynyl groups, hydroxyl groups, alkoxyl groups, hydrocarbyl groups, (meth)acrylate groups, sulfur-containing groups such as thiol, and nitrogen-containing groups such as amines and quaternary ammonium groups.

“(Meth)acrylate” refers to “methacrylate and/or acrylate”.

“Particle size”, “average particle size”, and “particle diameter” are interchangeable and refers to volume-average diameter (Dᵥ) for the particles as determined by dynamic light scattering. Prepare samples of particles as 1-5 wt % solutions in water and analyze the samples on a Microtrac Nanotrac Wave device equipped with a polytetrafluoroethylene cell. Collect data with a 30 second run time until three consistent results are obtained. Use an analysis method for transparent, spherical, 1.42 refractive index particles for all samples.

In one aspect, the present invention is a composition comprising a core-shell polyorganosiloxane particle. The composition can consist of the core-shell polyorganosiloxane particle or can comprise the core-shell polyorganosiloxane particle in combination with other components.

The core-shell polyorganosiloxane particle has an average particle size of 50 nanometers (nm) or more, and can an average particle size of 60 nm or more, 80 nm or more 90 nm or more, even 100 nm or more while at the same time has an average particle size of 150 nm or less and can have an average particle size of 130 nm or less, 110 nm or less, even 100 nm or less.

The shell of the core-shell polyorganosiloxane particle is greater than zero weight-percent (wt %) and can be one wt % or more, 2 wt % or more, 3 wt % or more, 4 wt % or more, 5 wt % or more, 6 wt % or more, 7 wt % or more, 8 wt % or more, 9 wt % or more, 10 wt % or more 12 wt % or more, even 15 wt % or more while at the same time is typically 20 wt % or less, and can be 18 wt % or less, 16 wt % or less, 14 wt % or less, 12 wt % or less, 10 wt % or less 8 wt % or less, 6 wt % or less, 5 wt % or less, even 4 wt % or less of the core-shell polyorganosiloxane particle weight. Determine wt % of the shell relative to the core-shell polyorganosiloxane particle weight by dividing the amount of shell monomer added by the sum of shell and core monomers used to make the particle and multiplying by 100%.

The shell accounts for less than (that is, the “% shell diameter” is less than) 25 percent (%), preferably 20% or less, 18% or less, 16% or less, 14% or less, 12% or less, 10% or less, 8% or less, 6% or less, 5% or less, and can account for 4% or less, 3% or less, 2% or less or even one % or less of the particle diameter. Determine the % shell diameter using the following calculation, where core size is the particle size of the core particle prior to adding a shell:

% shell diameter=[1−(core particle size)/(core-shell particle size)]*100%

The core of the core-shell polyorganosiloxane particle is a core polyorganosilsesquioxane. The core polyorganosilsesquioxane is a polysiloxane resin comprising siloxane units where at least 90 mol-percent (mol %), and possibly 95 mol % or more, even 98 mol % or more of the siloxane resin units are R′SiO_{3/2} siloxane units where R′ is independently in each occurrence selected from a group consisting of alkyl groups, preferably an alkyl group having from 1-10 carbon atoms, more preferably R′ is selected from methyl, ethyl, propyl, butyl, pentyl and hexyl groups. Most preferably, R′ is methyl. The core polyorganosilsesquioxane typically also contains ZO—SiO_{3/2} siloxane units and can contain or be free of (ZO)₂SiO_{2/2} siloxane units where ZO refers in each occurrence to a hydroxyl or alkoxyl group. Alkoxyl groups are typically alkoxyl groups containing one or more, and can contain 2 or more, even 3 or more carbon atoms while at the same time typically contains 8 or fewer, 6 or fewer, 5 or fewer, 4 or fewer, 3 or fewer 2 or fewer or even one carbon atom. Desirably, the core polyorganosilsesquioxane resin consists of R′SiO_{3/2} siloxane units and optionally ZO—SiO_{3/2} siloxane units and/or (ZO)₂SiO_{2/2} siloxane units.

The core polyorganosilsesquioxane is desirably “essentially non-reactive”, which means that they contain less than 30 mol %, preferably 20 mol % or less, 10 mol % or less, even 5 mol % or less, 3 mol % or less, 2 mol % or less, even one mol % or less —OZ groups relative to total moles of silicon atoms on average per molecule. In contrast, reactive additives such as silanes have 100 mole-percent or more such reactive groups based on total moles of silicon atoms on average per molecule. The concentration of reactive groups can be determined for a polyorganosilsesquioxane by infrared spectroscopy and nuclear magnetic resonance spectroscopy (NMR) using the following procedure: collect a ²⁹Si NMR on a methyl silsesquioxane resin synthesized in methylisobutyl ketone (MIBK) to produce a soluble silanol functional methyl silsesquioxane resin (see example in next paragraph). Determine the silanol content for this resin from the NMR as mol % OH as compared to Si and use that value to calibrate the concentration of OH (peak at 1270 cm⁻¹) in an infrared spectrum of the same methyl silsesquioxane resin. Using this type of calibration, the infrared spectrum of a polyorganosilsesquioxane resin can be used to determine the concentration of —OH and other reactive groups by infrared spectroscopy even if the resin is non-soluble.

As an example of a water soluble silsesquioxane resin synthesis in MIBK, one can follow the following procedure: Load a 2 L 3-nech round bottom flask with 737.1 g deionized water and 334.6 g MIBK. Equip the flask with a polytetrafluoroethylene stir paddle, thermometer, and water-cooled condenser. Cool the flask contents to 10° C. using an ice-water bath. Add a premixed solution of methyltrichlorosilane (240.0 g) and MIBK (143.4 g) slowly over 4 minutes 50 seconds. An exothermic reaction raised the temperature to 44° C. Mix for 5 minutes with ice-water bath removed. The temperature drops to 39° C. Transfer the reaction mixture into a one-liter 3-neck round bottom flask with a bottom drain and then remove the aqueous layer along with rag layer. Wash multiple times at room temperature with approximately 60 milliliters of deionized water for each wash until the final wash water has a pH of 4.0. Pressure filter through a 5.0 micrometer filter to obtain a clear filtrate. Strip resin to dryness using a rotovaporator. Remove the bulk of the solvent at 30° C. (15 minutes) and then the remainder at 110° C. (25 minutes). Pour out the resin in an oven and put in an oven at 110° C. for 25 minutes. Resulting resin is brittle solid at 25° C. with slight haze. It is soluble in tetrahydrofuran and deuterated chloroform, but not toluene. Resin has a number averaged molecular weight of 1,415 and a weight average molecular weight of 5,975. Average OH concentration is 36.49 mol % relative to Si atoms.

The shell of the core-shell polyorganosiloxane particle comprises a shell polyorganosiloxane that is a functionalized polyorganosiloxane that is different from the core polyorganosilsesquioxane. Typically, the shell polyorganosiloxane has an average chemical formula (I):

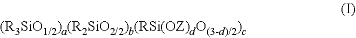

wherein:
each R is independently selected from group consisting of hydrocarbyl groups (such as alkyl, alkenyl, or aryl groups), halogenated hydrocarbyl groups (such as 3,3,3-trifluoropropyl groups); (meth)acrylate groups, sulfur-containing groups (such as thiol groups), nitrogen-containing groups (such as quaternary ammonium groups), and phosphorous-containing groups;
each (OZ) group is independently selected from hydroxyl, methoxyl and ethoxyl groups;
subscript a is the mole-ratio of (R₃SiO_{1/2}) units in the shell polyorganosiloxane and has a value in a range of 0 to 0.4, preferably subscript a is 0 or more, 0.1 or more, 0.2 or more, even 0.3 or more while at the same time is 0.4 or less, 0.3 or less, 0.2 or less, or even 0.1 or less, and can be zero;
subscript b is the mole-ratio of (R₂SiO_{2/2}) units in the shell polyorganosiloxane and has a value in a range of 0 to 0.3, preferably subscript b is 0 or more, 0.1 or more, even 0.2 or more while at the same time is 0.3 or less, and can be 0.2 or less, even 0.1 or less, and can be zero;
subscript c is the mole-ratio of (RSi(OZ)_{d}O_{(3-d)/2)} units in the shell polyorganosiloxane and has a value in a range of 0.5 to 1.0, preferably subscript c is 0.5 or more, 0.6 or more, 07 or more, 0.8 or more, even 0.9 or more, while at the same time is 1.0 or less, and can be 0.9 or less, 0.8 or less, 0.7 or less, or even 0.6 or less;
the sum of subscripts a, b, and c is 1.0; and wherein
subscript d is independently in each occurrence has a value in a range of zero to 2, provided that there is one mole-percent (mol %) or more and can be 5 mol % or more, 10 mol % or more, 20 mol % or more, 30 mol % or more, even 40 mol % or more while at the same time typically has 50 mol % or less and can have 40 mol % or less, 30 mol % or less, 20 mol % or less, 10 mol % or less, even 5 mol % or less OZ groups relative to moles of silicon atoms in the molecule.

The shell polyorganosiloxane is on the outside (exposed surface) of the core. Desirably, the shell polyorganosiloxane forms a continuous coating over the core. The core-shell polyorganosiloxane particle can comprise two or more, even three or more different shells around the core with additional shells residing over another shell. Each shell can be as thin as a monolayer thick and yet accounts for less than 20% of the diameter of the core-shell polyorganosiloxane particle. Desirably, the combined thicknesses of all the shells contribute to 20% or less of the core-shell polyorganosiloxane particle diameter.

The composition can further comprise an aqueous continuous phase with the polyorganosiloxane particles dispersed in the aqueous continuous phase to form an aqueous dispersion or dispersion. The polyorganosiloxane particles are made as an aqueous dispersion. The polyorganosiloxane particles can be isolated from the aqueous continuous phase by removing the aqueous phase. Typically, however, the particles are used as an aqueous dispersion. The concentration of polyorganosiloxane particle in the aqueous continuous phase when the composition is an aqueous dispersion is not technically limited. However, typically, the concentration of polyorganosiloxane particles is 5 wt % or higher, and can be 10 wt % or higher while at the same time are typically 15 wt % or less and can be 10 wt % or less relative to water phase weight.

The composition of the present invention can further comprise an anionic surfactant, and typically does particularly when the composition is an aqueous dispersion. The anionic surfactant can be adsorbed to the polyorganosiloxane particles, which is usually the case if the composition is not an aqueous dispersion of the polyorganosiloxane particles. When the composition is an aqueous dispersion, the surfactant can be dispersed in the aqueous phase and either adsorbed or just associated in a stabilizing way with the dispersed polyorganosiloxane particles. The concentration of anionic surfactant is typically 20 wt % or less, and can be 15 wt % or less, 10 wt % or less, 9 wt % or less, 8 wt % or less, 7 wt % or less, 6 wt % or less, 5 wt % or less, 4 wt % or less, 3 wt % or less, 2 wt % or less, even one wt % or less while at the same time is zero wt % or more and can be 0.5 wt % or more, one wt % or more, 2 wt % or more, 3 wt % or more, 4 wt % or more, 5 wt % or more, 6 wt % or more, 7 wt % or more, 8 wt % or more, 9 wt % or more, even 10 wt % or more relative to weight of the core polyorganosilsesquioxane, or even the entire core-shell polyorganosiloxane particle weight.

The composition can comprise some ammonium hydroxide and/or alcohol components that are residual from a reaction used to make the core-shell particles. Stripping these from the composition can result in compositions free of either or both ammonium hydroxide and alcohol.

In another aspect, the present invention is a method for making the composition of the present invention and is the only means currently known for making the composition of the present invention. The process comprises performing the following steps sequentially: (a) feeding a core alkyltrialkoxy silane into an aqueous solution of base and anionic surfactant while stirring in order to polymerize the core alkyltrialkoxy silane into polyorganosilsesquioxane core particles dispersed in the aqueous solution; and then (b) feeding a first polymerizable shell silane that is different from the core alkyltrialkoxy silane into the aqueous solution containing dispersed polyorganosilsesquioxane core particles while stirring to polymerize the first polymerizable shell silane around the core particles to form a dispersion of core-shell polyorganosiloxane particles.

Step (a)—Core Particle Formation

The aqueous solution comprises a base. The base can be any aqueous soluble base in broadest scope of the invention. Typically, the base is ammonia. The base is typically present at a concentration of 0.005 moles or more, and can be present at a concentration of 0.010 moles or more, 0.02 moles or more, 0.03 moles or more, 0.04 moles or more, 0.05 moles or more, 0.06 moles or more, 0.07 moles or more, 0.08 moles or more, 0.09 moles or more, even 0.10 moles or more while at the same time is typically present at a concentration of 0.2 moles or less, 0.15 moles or less, even 0.10 moles or less based on liters of water in the aqueous solution.

The aqueous solution also comprises an anionic surfactant. The anionic surfactant is typically a sulfonate, preferably a disulfonate. Desirably, the anionic surfactant is an alkyl(dodecyl)diphenyloxide disulfanate such as that available under the name DOWFAX™ 2A1 (DOWFAX is a trademark of The Dow Chemical Company). The anionic surfactant is typically present at a concentration of 0.06 moles or more, 0.07 moles or more, 0.08 moles or more, 0.09 moles or more, 0.10 moles or more and can be present at a concentration of 0.12 moles or more while at the same time is typically present at a concentration of 0.15 moles or less, even 0.14 moles or less, 0.13 moles or less, 0.12 moles or less, 0.11 moles or less, 0.10 moles or less, or even 0.09 moles or less based on moles of core alkyltrialkoxy silane fed into the aqueous solution in step (a).

Desirably, the aqueous phase is free of cationic and/or nonionic surfactants.

The core alkyltrialkoxy silane desirably comprises an “alkyl” group and “alkoxy” groups that have one or more, and can have 2 or more, 3 or more, even 4 or more carbon atoms while at the same time typically has 8 or fewer, 7 or fewer, 6 or fewer, 5 or fewer, 4 or fewer, 3 or fewer, 2 or fewer, or even just one carbon atom. Most desirably, the “alkyl” group is a methyl group and each alkoxy group is a methoxy group.

The amount of core alkyltrialkoxy silane fed into the aqueous solution is typically 0.10 wt % or more, 12 wt % or more, 14 wt % or more, 16 wt % or more, 18 wt % or more, even 20 wt % or more while at the same time is typically 25 wt % or less, even 24 wt % or less, 23 wt % or less, 22 wt % or less, 20 wt % or less, 18 wt % or less, 16 wt % or less, 12 wt % or less, even 10 wt % or less based on weight of water in the aqueous solution. Adding too much core alkyltrialkoxy silane can result in a core particle size that is too large while adding too little core alkyltrialkoxy silane can result in a core particle size that is too small.

Feed the core alkyltrialkoxy silane into the aqueous solution at a rate of 2.00 milliliters per minute (mL/min) or slower, preferably 1.80 mL/min or slower, 1.70 mL/min or slower, 1.65 mL/min or slower, or even 1.60 mL/min or slower, 1.55 mL/min or slower, or 1.50 mL/min or slower. Feeding faster than 2.00 m/min can result in core particle sizes that are too large. Generally, feeding slowly is not problematic technically but for efficiency it is desirable to feed as fast as possible. Therefore, it is also desirable to feed the core alkyltrialkoxy silane into the aqueous solution at a rate of 1.20 m/min or faster, preferably 1.30 m/min or faster, 14.0 mL/min or faster, 15.0 mL/min or faster, even 1.60 m/min or faster. Most desirably, the feed rate target is 1.65 m/min.

Desirably, the temperature of the aqueous solution while preparing the core particles can be 20° C. or higher, 25° C. or higher, 30° C. or higher, 40° C. or higher, even 50° C. or higher or 60° C. or higher while at the same time is generally 90° C. or lower, 80° C. or lower, 70° C. or lower, even 60° C. or lower. Most commonly, maintain the temperature of the aqueous solution at a temperature in a range of 25° C. to 60° C. while preparing the core polyorganosilsesquioxane particles.

Continue stirring the aqueous solution throughout the addition of the core alkyltrialkoxy silane to facilitate particle formation. Desirably, keep stirring for 10 minutes or more, 20 minutes or more, even 30 minutes or more after the core alkyltrialkoxy silane has been completely added to the aqueous solution to ensure thorough polymerization of the core alkyltrialkoxy silane to form polyorganosilsesquioxane core particles dispersed in the aqueous solution.

If desired, draw an aliquot of the aqueous solution containing the core polyorganosilsesquioxane and use it to determine the particle size of the core polyorganosilsesquioxane. The core polyorganosilsesquioxane particle size is desirably 150 nm or less and at the same time is typically 30 nm or greater, preferably 40 nm or greater and can be 50 nm or greater so that after polymerizing a shell to the core polyorganosilsesquioxane the final core-shell polyorganosiloxane particle will have an average particle size in a range of 50-150 nm.

Step (b)—Applying Shell to the Core Particle

After forming the core polyorganosilsesquioxane particles, the next step is to apply a shell around the core polyorganosilsesquioxane particles. Desirably, this step is performed directly after formation on the polyorganosilsesquioxane core particles. However, it is possible to have a delay between forming the polyorganosilsesquioxane core particles and forming the shell around them and even to cool and cease stirring the aqueous dispersion of core particles between step (a) and step (b).

Desirably, the temperature of the aqueous solution while preparing the applying the shell to the core polyorganosilsesquioxane particles can be 20° C. or higher, 25° C. or higher, 30° C. or higher, 40° C. or higher, even 50° C. or higher or 60° C. or higher while at the same time is generally 90° C. or lower, 80° C. or lower, 70° C. or lower, even 60° C. or lower. Most commonly, maintain the temperature of the aqueous solution at a temperature in a range of 25° C. to 60° C. while preparing the core polyorganosilsesquioxane particles.

Form at least one (a first shell) around the core particles and optionally form one or more addition shell around the first shell. The combination of all shells around the core particles provides a % shell diameter that is 25% or less, and can be 20% or less, 15% or less, 10% or less, 5% or less, 1% or less of the core-shell particle diameter. The shell thickness can be as little as a monolayer around the core particle.

Feed first polymerizable shell silane into the stirring aqueous solution containing the core particles at a rate that is typically 0.5 mL/min or faster, and can be 0.75 mL/min or faster, 1.0 mL/min or faster, 1.25 mL/min or faster, even 1.50 mL/min or faster while at the same time is desirably 1.65 mL/min or slower, and can be 1.50 mL/min or slower, 1.25 m/min or slower, 1.0 m/min or slower, even 0.75 mL/min or slower. Slower feed rates can be desirable to facilitate adsorption of the first polymerizable shell silane onto core particles rather than agglomerating into separate particles that might polymerize apart from a core particle.

The amount of first polymerizable shell silane fed into the aqueous solution containing dispersed core particles controls the thickness of the first shell that forms around the core particles. The thickness of the first shell provides a % shell diameter that is 25% or less, and can be 20% or less, 15% or less, 10% or less, 5% or less, 1% or less of the core-shell particle diameter. The first shell thickness can be as little as a monolayer around the core particle.

Typically, feed 2 wt % or more and possibly 5 wt % or more, 10 wt % or more, 20 wt % or more, 30 wt % or more, even 40 wt % or more while at the same time 50 wt % or less, 40 wt % or less, 30 wt % or less, 20 wt % or less, even 10 wt % or less or 5 wt % or less of first polymerizable shell silane relative to core particle weight into the aqueous solution containing dispersed core particles to form a first shell around the core particles.

The first polymerizable shell silane creates a first shell around the core particle that desirably provides a desired chemical character to the resulting core-shell particle without requiring the entire core-shell particle to comprise polymer with the desired chemical character. This is desirable because polymers with a desired chemical character can be more expensive than the polyorganosilsesquioxane core particles of the present invention and/or can be difficult to prepare as particles in a controlled size range of the particles of the present invention. The polyorganosilsesquioxane core particles can be readily prepared to a controlled particle size in the range of the present invention and then covered with a shell polymer that imparts the desired chemical character to the particle. As a result, particles in the size range of the presently claimed invention are easily prepared for less cost than trying to prepare particles entirely of a polymer with the desired chemical character.

The first polymerizable shell silane is different from the core alkyltrialkoxy silane and desirably has at least one alkoxy group, preferably at least two alkoxy groups and can have three alkoxy groups to facilitate polymerization around the core particles in the basic aqueous solution. Examples of suitable first polymerizable shell silanes include any one or any combination of more than one silane selected from a group consisting of hydrocarbyltrialkoxy silanes, substituted-hydrocarbyltrialkoxy silane, dihydrocarbyldialkoxy silane, hexaalkyldisilazane, trialkoxy(3,3,3-trifluoroalkyl)silane, (3-mercaptopropyl)alkoxy silane and methacryloxypropyltrialkoxysilane. The hydrocarbyl groups can be alkyl, alkenyl, alkynyl or aryl, and the hydrocarbyl groups typically have one or more carbon atom and can have 2 or more, 3 or more, 4 or more, 5 or more, 6 or more, even 7 or more carbon atoms while at the same time typically have 8 or fewer carbon atoms. The substituted-hydrocarbyl groups are hydrocarbyl groups with one or more than one hydrogen substituted with a functional group. The alkoxy groups of the silanes generally are selected from alkoxy groups with one or more carbon atom and can have 2 or more, 3 or more, 4 or more, 5 or more, 6 or more, even 7 or more carbon atoms while at the same time typically have 8 or fewer carbon atoms.

Specific examples of suitable first polymerizable shell silanes include any one or any combination of more than one silane selected from a group consisting of methyltrimethoxysilane, ethyltrimethoxysilane, propyltrimethoxysilane, octyltrimethoxysilane, phenyltrimethoxysilane, vinyltrimethoxysilane, dimethyldimethoxysilane, trimethylmethoxysilane, hexamethyldisilazane, trimethoxy(3,3,3-trifluoropropyl)silane, (3-mercaptopropyl)trimethoxysilane, and methacryloxypropyltrimethoxysilane.

It is desirable to maintain stirring of the aqueous solution for 10 minutes or longer, preferably 20 minutes or longer, even 30 minutes or longer after completing feeding of the first polymerizable shell silane in order to ensure maximum polymerization of the silane. Once the first polymerizable shell silane has polymerized around the core particles the result is an aqueous dispersion of core-shell polyorganosiloxane particles of the present invention.

The method for making the composition of the present invention can further comprise one or more subsequent steps (each a step (c)) that occur after step (b), where each step (c) comprises feeding an additional polymerizable shell silane into the aqueous solution containing a dispersion of core-shell polyorganosiloxane particles while stirring. Feed rates and concentrations of the additional polymerizable shell silane can be selected from those identified for the first polymerizable shell silane. Each additional polymerizable shell silane can be selected from those identified as suitable for the first polymerizable shell silane. Polymerizing one or more additional shell silane onto the core-shell polyorganosiloxane particles produces core-shell polyorganosiloxane particles having multiple shells around a core.

The method can further include having a stabilizer present during either or both of steps (a) and steps (b). A suitable stabilizer includes polyvinylpyrrolidone (“PVP”). The stabilizer, when present, is typically present at a concentration at a concentration of 0.05 wt % or more, 0.075 wt % or more, 0.10 wt % or more 0.125 wt % or more, 0.15 wt % or more, even 0.175 wt % or more while at the same time is typically present at a concentration of 1.0 wt % or less, 0.75 wt % or less, 0.50 wt % or less, 0.25 wt % or less, 0.15 wt % or less based on the combined weight of all the components present. The method and resulting core-shell polyorganosiloxane particle can be free of stabilizers such as PVP.

### EXAMPLES

Prepare the following examples using the materials described in Table 1.

TABLE 1

| Component | Description | Source |
|---|---|---|
| MTM | Methyltrimethoxysilane | Available under the name |
| | | XIAMETER ™ OFS-6070 from The |
| | | Dow Chemical Company. |
| PhTM | Phenyltrimethoxysilane | Available under the name |
| | | XIAMETER ™ OFS-6124 from The |
| | | Dow Chemical Company. |
| ViTM | Vinyltrimethoxysilane | Available from Sigma Aldrich. |
| Me₃Si(OMe) | Trimethylmethoxysilane | Available under the name DOWSIL ™ |
| | | Z-6013 from the Dow Chemical |
| | | Company. |
| HMDZ | Hexamethyldisilazane | Available under the name |
| | | XIAMETER ™ PMS-6079 from The |
| | | Dow Chemical Company. |
| F₃PrTM | Trimethoxy(3,3,3- | Available from Sigma Aldrich. |
| | trifluoropropyl)silane | |
| C8TM | Trimethoxy(octyl)silane | Available from Sigma Aldrich. |
| C3TM | Trimethoxy(propyl)silane | Available from Gelest. |
| | (note: distilled prior to use) | |
| MPTM | (3-Mercaptopropyl)trimethoxysilane | Available from Sigma Aldrich. |
| MATM | Methacryloxypropyltrimethoxysilane | Available from Sigma Gelest. |
| Anionic | Alkyl(dodecyl)diphenyloxide | Available under the name DOWFAX ™ |
| Surfactant | disulfonate. 45 wt % in water. | 2A1 from the Dow Chemical Company. |
| PVP | Polyvinylpyrrolidone (40,000 | Available from Sigma Aldrich. |
| | molecular weight) | |
| NH₄OH | Ammonium Hydroxide (aqueous | Available from Fisher Scientific. |
| | 29%) | |

XIAMETER is a trademark of Dow Corning Corporation; DOWSIL and DOWFAX are trademarks of The Dow Chemical Company.

Particle Size Characterization is as described previous above under definition of “particle size.”

Confirmation of core-shell structure for the particles is done by examination of transmission electron micrograph (TEM) images of the particles or, if that is not possible, by x-ray photoelectron spectroscopy (XPS) and secondary ion mass spectrometry (SIMS) analysis of the particles. From TEM images the shell is often apparent as a different color domain from the core, typically a lighter colored halo around the core. From XPS and SIMS the concentration of functional groups on the surface of the particle can be determined and compared to the concentration expected for a shell versus a copolymer configuration with the core polymer. Notably, penetration depth for XPS analysis is only about 5-10 nm so examination is truly of the surface chemistry.

Prepare TEM samples by two different methods. For the first method, dilute two drops of sample dispersion in 10 mL of deionized water. Nebulize the diluted sample onto a copper TEM grid (200 mesh with Formvar/carbon support) at 25° C. For the second method follow a sectioning preparation method. Apply a drop of sample dispersion to a metal pin mount. Allow the drop to dry at 25° C. for 48 hours. Section the dried sample into 100 nm films at −80° C. in a Leica Ultracut EM UC7/FC7 cryo-ultramicrotome and transfer the thin films onto a 200 mesh copper grid with Formvar/carbon support. In both cases, the TEM sample are imaged without staining. Conduct TEM imaging in a FEI Tecnai G2 Spirit BiTwin TEM equipped with a LaB₆ filament operating at 120 KV. Acquire micrographs with a Gatan Oneview camera at 2K resolution.

Prepare samples for XPS analysis on both IEC treated and dialysis treated core-shell sample particles. Prepare solid samples by drying the samples in a vacuum oven at 25° C. for at least 24 hours to form powdered samples. Place a portion of each powdered sample in copper DSC lids and mount them using doubled-sided SEM adhesive tabs. Analyze in four locations. Obtain low-resolution survey spectra (160 eV pass energy) and high-resolution O 1 second, C 1 second, Si 2p spectra (20 eV pass energy at each location. Additionally obtain high-resolution S 2p spectra at the mercaptopropyl sample locations. The area of analysis is nominally 0.4 millimeters by 0.9 millimeters at all locations. Obtain data on a Kratos Analytical AXIS Nova XPS using monochromatic Al Ka x-ray source (1486.6 eV) operating at 150 Watts. Use a low-energy electron flood for surface charge compensation. Calculate expected surface Si composition of a pure film of the capping silane assuming at least 10 nm thickness.

### Exs 1-3

Prepare samples 1-3 in a 250 milliliter (mL) glass bottle with a polytetrafluoroethylene stirring bar. Add 54.2 grams (g) of water, 0.16 g NH₄OH, 0.09 g PVP and 0.87 g Anionic Surfactant components and stir to form a uniform solution. While stirring, add 12.8 g MTM component at a rate of 0.47 mL per minute (mL/min) using a syringe pump and continue stirring for 30 minutes after addition of MTM is complete. That forms an aqueous dispersion of core particles. Remove an aliquot (approximately 0.5 mL) of the aqueous dispersion for analysis of the seed particle size. Then feed the shell monomer (see Table 2) into the solution of seed particle at a rate of 0.5 mL/min. Continue mixing for one hour after adding all of the shell monomer to complete polymerization to form a dispersion of core-shell particles in aqueous solution. Run the process without active heating (approximately 25° C. ambient temperature).

Characterize the particle size of the core and the core-shell particles and confirm the core-shell particles have a core-shell structure.

TABLE 2

| | | |
|---|---|---|
| Ex 1 | Ex 2 | Ex 3 |

Shell Monomer

| | | | |
|---|---|---|---|
| PhTM (g) | 2.6 | — | — |
| ViTM | — | 2.6 | — |
| Me₂Si(OMe) | — | — | 0.05 |

Characterization

| | | | |
|---|---|---|---|
| Core Particle Size (nm) | 108 | 108 | 108 |
| Core-Shell structure? | Yes | Yes | Yes |
| Core-Shell Particle Size (nm) | 115 | 111 | 110 |
| % Shell Diameter | 6% | 3% | 2% |

### Exs 4-7

Seed Particle Dispersion. Into a 500 mL glass reaction vessel add 434 g deionized water, 0.6 g NH₄OH, 1.7 g anionic surfactant and 0.35 g PVP. Heat the combination of components to 60° C. while stirring for 30 minutes to equilibrate and form a uniform mixture. Add 51.30 g of MTM drop-wise while mixing using a syringe at a rate of 1.00 m/min. Once MTM addition is complete, allow the mixture to stir at 60° C. for 10 minutes to form an aqueous dispersion of seed particles.

Core Particle Dispersion. Into a 500 mL glass reaction vessel add deionized water (see Table 3 for amount), 0.6 mL NH₄OH, 1.7 g Anionic Surfactant, 0.35 g PVP and 21 g of the dispersion of seed particles. Stir and heat to 60° C. for 30 minutes. Add 51.3 g MTM drop-wise using a syringe at a rate of 1.65 mL/min. After MTM addition is complete, allow the mixture to stir at 60° C. for 10 minutes to form an aqueous dispersion of core particles. Characterize the particle size of the core particles. Continue on to preparing the Core-Shell Particle Dispersion while maintaining the Core Particle Dispersion at 60° C. and stirring.

Core-Shell Particle Dispersion. Into the 500 mL glass reaction vessel containing the Core Particle Dispersion, add the amount of shell monomer stated in Table 3 at a rate of 0.1 m/min while stirring the contents of the glass reaction vessel at 60° C. Continue stirring and heating at 60° C. for an hour after addition of core monomer is complete to form an aqueous Core-Shell Particle Dispersion.

Purification/Concentration. Filter the aqueous Core-Shell Particle Dispersion using a vacuum filtration set up and CHEMRUS™ disposable filter funnel with a 10 micrometer pore size polyethylene fritted disc to remove solid precipitants/sediments and then concentrate by removing methanol by-product and ammonia by rotary evaporating the Core-Shell Particle Dispersion at a temperature up to 50° C. Confirm the particle have core-shell structure. Characterize the particle size of the core-shell particles.

TABLE 3

| | | | |
|---|---|---|---|
| Ex 4 | Ex 5 | Ex 6 | Ex 7 |

Water or Shell Monomer

| | | | | |
|---|---|---|---|---|
| Deionized water (g) | 413 | 42 | 378 | 408 |
| HMDz (g) | 1.28 | — | — | — |
| F₃PrTm (g) | — | 3.46 | — | — |
| C8TM (g) | — | — | 3.72 | — |
| PhTM (g) | — | — | — | 3.15 |

Characterization

| | | | | |
|---|---|---|---|---|
| Core Particle Size (nm) | 111 | 111 | 111 | 111 |
| Core-Shell structure? | Yes | Yes | Yes | Yes |
| Core-Shell Particle Size | 110* | 108* | 108* | 108* |
| (nm) | | | | |
| % Shell Diameter | <1% | <1% | <1% | <1% |

*The final Core-Shell Particle Size cannot be less than the Core Particle Size. Uncertainty in the particle size measurement is 2-3% so these results indicate that the shell is less than 1% of the total particle size.

### Exs 8-11

Core Particle Dispersion. Into a 500 mL glass bottle add deionized water and Anionic Surfactant (see Table 4 for amounts). Add a magnetic stirring bar and stir at 25° C. for one minute. Quickly add 0.2 mL of NH₄OH. Cap the glass bottle with a plastic cap having two ports, one for a temperature probe and one for reagent addition. Heat the contents to 60° C. while stirring at 500 revolutions per minute. Allow the contents to equilibrate at 60° C. for 10-30 minutes then add 51.3 g of MTM drop-wise at a rate of 1.6 mL/min. Approximately 10 minutes into the addition the solution turns opaque. Addition of MTM takes approximately 40 minutes, after which maintain the resulting solution at 60° C. while stirring for 30 minutes to obtain an aqueous Core Particle Dispersion. Characterize the aqueous Core Particle Dispersion by dynamic light scattering to determine core particle size. Continue directly to synthesis of Core-Shell Particle Dispersion in the same glass bottle while maintaining at 60° C. and stirring.

Core-Shell Particle Dispersion. Add to the aqueous Core Particle Dispersion the Capping Monomer identified in Table 4 at a rate of 0.5 mL/min. Once Capping Monomer addition is complete continue stirring at 60° C. for one hours and then allow the solution to cool to 25° C. and then continue to stir at 25° C. for 12 hours to obtain an aqueous Core-Shell Particle Dispersion. Confirm the particle have a core-shell structure. Characterize the particle size of the core-shell particles.

TABLE 4

| | | | |
|---|---|---|---|
| Ex 8 | Ex 9 | Ex 10 | Ex 11 |

Water or Capping Monomer

| | | | | |
|---|---|---|---|---|
| Deionized water (g) | 434 | 435 | 439 | 435 |
| Anionic Surfactant (g) | 1.83 | 1.72 | 1.74 | 3.45 |
| C8TM (g) | 3.53 | — | — | — |
| MPTM (g) | — | 3.50 | — | — |
| C3TM (g) | — | — | 2.0 | — |
| MATM (g) | — | — | — | 4.22 |

Characterization

| | | | | |
|---|---|---|---|---|
| Core Particle Size (nm) | 90 | 85 | 89 | 94 |
| Core-Shell structure? | Yes | Yes | Yes | Yes |
| Core-Shell Particle Size (nm) | 91 | 92 | 92 | 97 |
| % Shell Diameter | 1% | 8% | 3% | 3% |

### Exs 12-15—Variations in Shell Thickness

Core Particle Dispersion. Prepare an aqueous Core Particle Dispersion in like manner as in Exs 8-11. Use such a Core Particle Dispersion to prepare the Core-Shell Particle Dispersions of Exs 12-15.

Core-Shell Particle Dispersion. To a 400 g sample of aqueous Core-Shell Particle Dispersion add 1.16 g Anionic Surfactant and heat with stirring to 60° C. and allow to stir for 30 minutes. Add to the aqueous Core Particle Dispersion the 3.5 g MPTM drop-wise at a rate of 0.2 mL/min. After addition is complete allow the solution to stir at 60° C. for one hour to obtain Ex 12. Remove 100 g of Ex 12 and analyze for particle size and confirm core-shell structure. To the remaining Ex 12 add 3.5 g MPTM drop-wise at a rate of 0.2 mL/min while stirring at 60° C. and continue stirring at temperature for one hour after addition is complete to obtain Ex 13. Remove 100 g of Ex 13 and analyze for particle size and confirm core-shell structure. To the remaining Ex 13 add 3.00 g MPTM drop-wise at a rate of 0.2 mL/min while stirring at 60° C. and continue stirring at temperature for one hour after addition is complete to obtain Ex 14. Remove 100 g of Ex 14 and analyze for particle size and confirm core-shell structure. To the remaining Ex 14 add 2.50 g MPTM drop-wise at a rate of 0.2 mL/min while stirring at 60° C. and continue stirring at temperature for one hour after addition is complete to obtain Ex 15. Analyze Ex 15 for particle size and confirm core-shell structure.

Table 5 provides characterization of the resulting Core-Shell Particles for Exs 12-15.

TABLE 5

| Characterization | Ex 12 | Ex 13 | Ex 14 | Ex 15 |
|---|---|---|---|---|
| Core Particle Size (nm) | 86 | 86 | 86 | 86 |
| Core-Shell structure? | Yes | Yes | Yes | Yes |
| Core-Shell Particle Size (nm) | 86 | 91 | 92 | 104 |
| % Shell Diameter | <1% | 5% | 6% | 17% |

### Comp Ex A-D

To a 250 mL glass bottle with a polytetrafluoroethylene stir bar, add 72 mL deionized water and 0.23 mL of NH₄OH, 0.12 g PVP and 1.16 g Anionic Surfactant. Stir to form a uniform solution. While stirring add dropwise add the Monomer Component that contains the monomer and amounts listed in Table 6 at a rate of 0.47 m/min. Once addition is complete, continue stirring at temperature for one hour to obtain an aqueous dispersion of particles. These are not core-shell structures. Characterize the particle size.

TABLE 6

| | | | |
|---|---|---|---|
| Comp | Comp | Comp | Comp |
| Ex A | Ex B | Ex C | Ex D |

Monomer

| | | | | |
|---|---|---|---|---|
| MTM (g) | 12.8 | — | 8.6 | 15.4 |
| PhTM (g) | 4.3 | 17.1 | 8.6 | 1.7 |

Characterization

| | | | | |
|---|---|---|---|---|
| Particle Size (nm) | 29 | 9 | 22 | 51 |
| Core-Shell structure? | No | No | No | No |

Comp Ex A, C and D are co-polymerizations of the core monomer used in the previous examples and a shell monomer used in some previous examples rather than sequential polymerization to form a core and then add a shell. The resulting particles do not have a core-shell structure.

Comp Ex B is a polymerization of just a shell monomer from a previous example. It also does not have a core-shell structure.

### Comp Ex E

Into a 500 mL glass bottle add 1.72 g Anionic Surfactant and 434 g deionized water and a magnetic stirring bar. Stir the mixture at 25° C. for one minute and then quickly add 0.2 mL of NH₄OH. Cap the jar with a plastic cap equipped with two ports, one for a temperature probe and one for reagent addition. Heat the solution to 60° C. while stirring and allow to continue stirring for 20 minutes after reaching temperature. Add 51.3 g MTM and 5.0 g C8TM drop-wise at a rate of 1.6 mL/min over 50 minutes. After addition is complete allow the solution to stir at 60° C. for one hour. Cool to 25° C. and continue stirring for 12 hours to obtain Comp Ex E. The resulting particle size if 51 nm.

Comp Ex E is an example of a copolymerization of the core monomer used in the previous examples and one of the shell monomers instead of a sequential polymerization to form a core and add a shell. The resulting particles do not have a core-shell configuration.

### Comp Ex F

Into a 100 mL glass bottle add 0.20 g Anionic Surfactant, 42.9 g deionized water, 5.05 g C8TM and a few drops of NH₄OH. Cap the jar and shake by hand for 30 seconds. Allow the solution to sit at 25° C. for 3-5 days with periodic shaking. A dispersion of polymer particles forms during that time as Comp Ex F. Comp Ex F has a particle size of 485 nm and does not have a core-shell structure.

### Comp Ex G

Into a 500 mL glass bottle add 1.83 g Anionic Surfactant, 434 g deionized water, and a magnetic stir bar. Begin stirring and then quickly add 0.2 mL of NH₄OH. Cap the glass bottle with a plastic cap having two ports, one for a temperature probe and one for adding reagents. Heat the solution to 60° C. while stirring. After stirring for 10 minutes at 60° C., add 45.1 g MPTM at a rate of 1.6 mL/min. Continue stirring at 60° C. for one hour after addition is complete. Cool the solution to 25° C. and continue stirring for 12 hours. The solution gelled during the course of MPTM addition and became more gelatinous during cooling and subsequent mixing.

### Comp Ex H

Into a 100 mL glass bottle add 0.41 g Anionic Surfactant, 43 g deionized water, 5.05 g MPTM and a few drops of NH₄OH. Cap the jar and shake by hand for 30 seconds. Allow the solution to sit at 25° C. for 3-5 days with periodic shaking. A dispersion of polymer particles forms during that time as Comp Ex H. Comp Ex H has a particle size of 96 nm and does not have a core-shell structure.

1. A composition comprising a core-shell polyorganosiloxane particle having an average particle size in a range of 50-150 nanometers, the core-shell polyorganosiloxane particle comprising:
(a) a core comprising a core polyorganosilsesquioxane; and
(b) a shell coating the core consisting of a shell polyorganosiloxane that is a functionalized polyorganosiloxane different from the core polyorganosilsesquioxane;
where the shell is greater than zero and less than 20 weight-percent of the core-shell polysiloxane particle weight and less than 25 percent of the particle diameter.

2. The composition of claim 1, where the composition is an aqueous dispersion that further comprises an aqueous continuous phase with the core-shell polyorganosiloxane particles dispersed therein.

3. The composition of claim 1, wherein the core polyorganosilsesquioxane is methyl silsesquioxane and the shell coating is a polyorganosiloxane different from the core polyorganosilsesquioxane and has an average chemical formula (I): 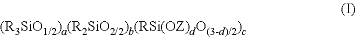
wherein each R is independently selected from group consisting of hydrocarbyl groups, halogenated hydrocarbyl groups, (meth)acrylate groups, sulfur-containing groups, nitrogen-containing groups, and phosphorous containing groups; each (OZ) group is independently selected from hydroxy, methoxy and alkoxy groups; subscript a is a value in a range of 0 to 0.4, subscript b is a value in a range of 0 to 0.3, subscript c is a value in a range of 0.5 to 1.0; the sum of subscripts a, b, and c is 1.0; and subscript d is independently in each occurrence a value in a range of 0-2 provided that there is one to 50 mole-percent OZ groups relative to moles of silicon atoms in the molecule.

4. The composition of claim 1 further comprising an anionic surfactant.

5. A method for preparing the composition of claim 1, the method comprising performing the following steps sequentially:
(a) feeding a core alkyltrialkoxy silane into an aqueous solution of base and anionic surfactant while stirring in order to polymerize the core alkyltrialkoxy silane into polyorganosilsesquioxane core particles dispersed in the aqueous solution; and
(b) feeding a first polymerizable shell silane that is different from the core alkyltrialkoxy silane into the aqueous solution containing dispersed polyorganosilsesquioxane core particles while stirring to polymerize the first polymerizable shell silane around the core particles to form a dispersion of core-shell polyorganosiloxane particles.

6. The method of claim 5, wherein the concentration of anionic surfactant is in a range of 0.06 to 0.15 moles per mole of core alkyltrialkoxy silane that is fed into the aqueous solution.

7. The method of claim 5, wherein step (a) requires feeding a total of 10 to 25 weight-percent core alkyltrialkoxy silane based on weight of water in the aqueous solution.

8. The method of claim 5, wherein step (b) requires feeding a total of 2-50 weight-percent first polymerizable shell silane based on weight of the core particles in the aqueous solution.

9. The method of claim 5, wherein the first polymerizable shell silane is any one or any combination of more than one silane selected from a group consisting of hydrocarbyltrialkoxy silane, aryltrialkoxy silane, dihydrocarbyldialkoxy silane, hexaalkyldisilazane, trialkoxy(3,3,3-trifluoroalkyl)silane, (3-mercaptopropyl)trimethoxy silane and methacryloxypropyltrimethoxysilane.

10. The method of claim 5, further comprising a step (c) after step (b), wherein step (c) feeding into the aqueous solution while stirring an additional polymerizable shell silane that is different from the core alkyltrialkoxy silane and first polymerizable shell silane to polymerize the additional polymerizable shell silane around both the shell from the first shell silane and the core of to form a dispersion of core-shell polyorganosiloxane particles having two layer shell layers around a core.
